(19) United States
(12) Patent Application Publication
(10) Pub. No.: US 2019/0224660 A1
(43) Pub. Date: Jul. 25, 2019

(54) SELECTIVE PORPHYRIN-CATALYZED ELECTROCHEMICAL REDUCTION OF CO2 INTO CO, IN PARTICULAR IN WATER

(71) Applicants: Centre National de la Recherche Scientifique (CNRS), Paris (FR); Universite Paris Diderot Paris 7, Paris (FR)

(72) Inventors: Marc Robert, Paris (FR); Jean-Michel Saveant, Paris (FR); Cyrille Costentin, Montreuil (FR); Arnaud Tatin, Paris (FR); Iban Azcarate, Paris (FR)

(73) Assignees: Centre National de la Recherche Scientifique (CNRS), Paris (FR); Universite Paris Diderot Paris 7, Paris (FR)

(21) Appl. No.: 16/317,060

(22) PCT Filed: Jul. 11, 2017
(86) PCT No.: PCT/EP2017/067452

§ 371 Date: Jan. 11, 2019

(30) Foreign Application Priority Data
Jul. 13, 2016 (EP) 16305904.1

(51) Int. Cl. B01J 31/18; C07F 15/02; C25B 1/00; C25B 11/12; C01B 32/40

(52) U.S. Cl. CPC B01J 31/1815; C07F 15/025; C25B 1/00; B01J 2531/025; C01B 32/40; B01J 2231/625; B01J 2531/842; C25B 11/12

(57) ABSTRACT

The present invention relates to the use of complexes of water soluble porphyrins of formula (I). The present invention relates to water soluble porphyrins of formula (I), wherein R₁ to R₁₁ and R₁′ to R₈′ are as defined in claim 1, their iron complexes, use thereof as catalysts for the selective electrochemical reduction of CO₂ into CO, electrochemical cells comprising them, and methods for reducing electrochemically CO₂ into CO using said complexes or said electrochemical cells, thereby producing CO or syngas.

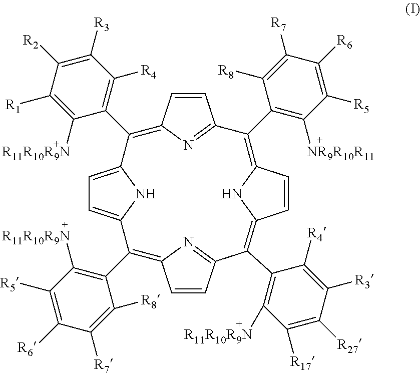

The present invention relates to water soluble porphyrins, their iron complexes, use thereof as catalysts for the selective electrochemical reduction of CO₂ into CO, electrochemical cells comprising them, and methods for reducing electrochemically CO₂ into CO using said complexes or said electrochemical cells, thereby producing CO or syngas.

Despite the increasingly frequent use of renewable energies to produce electricity avoiding concomitant production of CO₂, it is reasonable to consider that CO₂ emissions, in particular resulting from energy production, will remain high in the next decades. It thus appears necessary to find ways to capture CO₂ gas, either for storing or valorization purposes.

Indeed, CO₂ can also be seen, not as a waste, but on the contrary as a source of carbon. For example the promising production of synthetic fuels from CO₂ and water has been envisaged.

However, CO₂ exhibits low chemical reactivity: breaking one its C—O bonds requires an energy of 532 kJ/mol. Moreover, CO₂ electrochemical reduction to one electron occurs at a very negative potential, thus necessitating a high energy input, and leads to the formation of a highly energetic radical anion (CO₂^{•-}). Catalysis thus appears mandatory in order to reduce CO₂ and drive the multi-electronic and multi-proton reduction process, in order to obtain thermodynamically stable molecules. In addition, direct electrochemical reduction of CO₂ at inert electrodes is poorly selective, yielding formic acid in water, while it yields a mixture of oxalate, formate and carbon monoxide in low-acidity solvents such as DMF.

CO₂ electrochemical reduction thus requires catalytic activation in order to reduce the energy cost of processing, and increase the selectivity of the species formed in the reaction process.

Several low-oxidation state transition metal complexes have been proposed to serve as homogeneous catalyst for this reaction in non-aqueous solvents such as N,N′-dimethylformamide (DMF) or acetonitrile (see Chem. Soc. Rev. 2013, 42, 2423). Among them, electrochemically generated Fe⁰ porphyrin complexes have been shown to be good catalysts provided they are used in the presence of Brönsted or Lewis acids (see J. Am. Chem. Soc. 1996, 118, 1769; J. Phys. Chem. 1996, 100, 19981). More recent investigations have extended the range of Brönsted acids able to boost the catalysis of the CO₂-to-CO conversion by electrogenerated Fe⁰-TPP without degrading the selectivity of the reaction. They have also provided a detailed analysis of the reaction mechanism (see J. Am. Chem. Soc. 2013, 135, 9023).

This is notably the case with phenol, which gave rise to the idea of installing prepositioned phenol groups in the catalyst molecules “CAT” and “FCAT” depicted below. The result was indeed a remarkably efficient and selective catalyst of the CO₂-to-CO conversion in particular in terms of catalytic Tafel plots (Turnover frequency vs. overpotential) with no degradation of the CO (vs. H₂) faradaic yield (see Science 2012, 338, 90; and Proc. Natl. Acad. Sci. U.S.A. 2014, 111, 14990-14994).

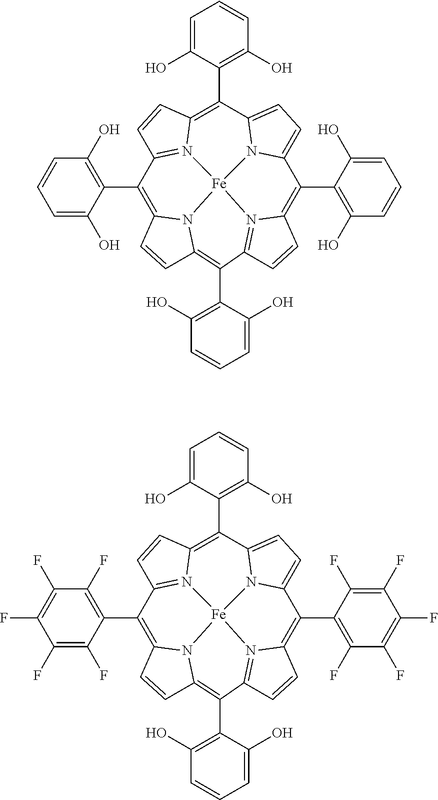

### Structure of the “CAT” Catalyst (Left) and “FCAT” Catalyst (Right)

However, from the point of view of practical applications, the use of non-aqueous solvents is not optimal. It would be preferable indeed to be able to use water as the solvent, which would render more viable the CO₂-to-CO half-cell reaction as well as its association with a water-oxidation anode through a proton-exchange membrane for instance.

CO₂ is poorly soluble in water ([CO₂]=0.0383 M), and is partially converted (K_{hydration}=1.7×10⁻³) into carbonic acid, CO₃H₂, which has a first ionization pKa of 3.6, i.e., an apparent pKa of 6.4. Because of these features, the CO₂-to-CO conversion is expected to be challenged by H₂ evolution from reduction of carbonic acid and/or hydrated protons. Cobalt based catalyst cobalt tetrakis(4-trimethylammoniophenyl)porphyrin has been previously reported as an efficient catalyst for reduction of CO₂ into CO in water (Cao et al Acta Chimica Sinica 1986, 44, 220, pp 133-139). However, high CO₂ pressures are required to obtain high faradic efficiency and turnover numbers (TON) under reasonably low overpotential.

A water-soluble water porphyrin has been developed—Fe-p-TMA—which proved very efficient for catalyzing the reduction of CO₂ into CO both in organic solvents and in water (see Proc. Natl. Acad. Sci. U.S.A., 2015, 112, 6882).

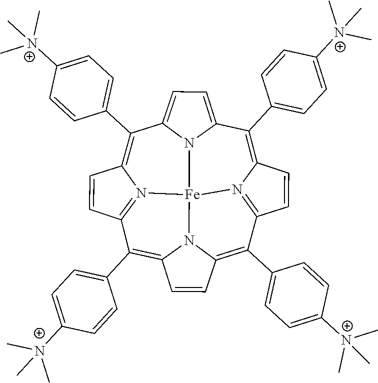

### Structure of Fe-p-TMA

There is however still a need for catalysts for the selective and/or tunable electrochemical reduction of CO₂ into CO based on iron porphyrins with an even higher efficiency (i.e. high faradic yield, higher Turnover Number (TON) and Turnover Frequency (TOF)), higher selectivity and higher stability, while operating at low overpotential (in absolute value), and preferably under low CO₂ pressure, in particular in water. Moreover, it would be advantageous that the catalyst be efficient when operated homogeneously as well as when immobilized on an electrode surface.

### SUMMARY OF THE INVENTION

Applicants surprisingly found that specific water soluble iron porphyrins comprising four ortho anilinium substituents are particularly effective and selective catalysts for the electrochemical reduction of CO₂ into CO in water.

The catalyst of the present invention exhibits high and tunable selectivity in organic solvents such as DMF as well as in water. Both homogeneous and heterogeneous catalytic systems are efficient, in particular at low overpotential and low CO₂ pressure.

Therefore, in a first aspect, the present invention relates to an iron complex of a porphyrin of formula (I) below:

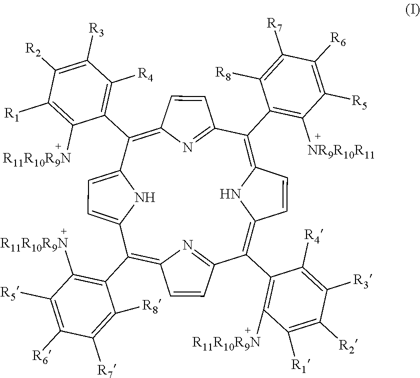

wherein R₁ to R₈ and R₁′ to R₈′ are independently selected from the group consisting of H, OH, F and C₁-C₆-alkyl,

provided that at least 2 of R₁-R₄ are H, at least 2 of R_{1′}-R_{4′} are H, at least 2 of R₅-R₈ are H, and at least 2 of R_{5′}-R_{8′} are H, and

R₉, R₁₀ and R₁₁ are independently selected from a C₁-C₄-alkyl group,

and salts thereof.

In a second aspect, the present invention relates to the use of the iron complex of the invention as catalyst for the electrochemical reduction of CO₂ into CO, in particular in water.

In a third aspect, the present invention relates to a two-compartment electrochemical cell comprising at least:
a cathodic compartment with a cathode and a cathodic electrolyte solution comprising a cathodic solvent and a cathodic supporting electrolyte, and the substrate CO₂,
an anodic compartment with an anode and an anodic electrolyte solution comprising a solvent and an anodic supporting electrolyte,
a power supply providing the energy necessary to trigger the electrochemical reactions involving the substrate,

and further comprising the iron complex of the invention.

In a fourth aspect, the present invention relates to a method of reducing electrochemically CO₂ into CO using the electrochemical cell of the invention.

### Definitions

As used herein, the words “include,” “comprise, “contain”, and their variants, are intended to be non-limiting, such that recitation of items in a list is not to the exclusion of other like items that may also be useful in the compositions, devices and methods of this invention.

According to the present invention, an alkyl is understood to mean a linear or branched, saturated hydrocarbon chain. Examples of C₁-C₆ alkyl are methyl, ethyl, n-propyl, i-propyl, n-butyl, s-butyl, t-butyl, pentyl and n-hexyl.

According to the present invention, a C₁-C₆ alcohol is understood to mean a C₁-C₆ alkyl substituted by at least one hydroxyl group (OH group), preferably only one hydroxyl group. The C₁-C₆ alcohol may be linear or branched, and is saturated. Preferably, the C₁-C₆ alcohol is a C₁-C₄ alcohol. Examples of C₁-C₄ alcohol are hydroxymethyl, 1-hydroxyethyl, 2-hydroxyethyl, 1-hydroxypropyl, 2-hydroxypropyl, 3-hydroxypropyl, 1-hydroxy-1-methylethyl, 2-hydroxy-1-methylethyl, 1-hydroxybutyl, 2-hydroxybutyl, 3-hydroxybutyl, 4-hydroxybutyl, 1-hydroxy-2-methylpropyl, 2-hydroxy-2-methylpropyl, 3-hydroxy-2-methylpropyl, 1-hydroxy-1-methylpropyl, 2-hydroxy-1-methylpropyl, 3-hydroxy-1-methylpropyl, (hydroxymethyl)-1-propyl, 1,2-dihydroxyethyl.

As used herein, “overpotential (η)” is understood as a potential difference between the apparent standard potential of the CO₂/CO couple (E°_{CO2/CO}) and the potential at which the reduction is experimentally observed (E), according to the following equation: η=E°_{CO2/CO}−E.

As used herein, the “TurnOver Number (TON)” represents the number of moles of substrate that a mole of active catalyst can convert.

As used herein, the “TurnOver Frequency (TOF)” refers to the turnover per unit of time: TOF=TON/t, with t representing the time of catalysis.

As used herein, the acronym NHE is understood as “Normal Hydrogen Electrode”

As used herein, the acronym SCE is understood as “Saturated Calomel Electrode”.

Electrolysis is for instance performed in an electrochemical cell, which typically comprises at least:
an electrolyte solution comprising the solvent, a supporting electrolyte as a salt, and the substrate;
a power supply providing the energy necessary to trigger the electrochemical reactions involving the substrate; and
two electrodes, i.e. electrical conductors providing a physical interface between the electrical circuit and the solution.

As used herein, the “faradic yield of an electrochemical cell” aimed at producing CO (or H₂) gas through electrochemical reduction of CO₂ gas is the ratio of the amount of electrons (in Coulomb) used to produce CO (or H₂) gas relative to the amount of electrons (in Coulomb) furnished to the electrochemical system by the external electric source. The faradic yield is expressed in %.

According to the present invention, a “homogeneous catalyst” is a catalyst which is contained in the same phase as the reactants. In contrast, a “heterogeneous catalyst” is contained in a phase which differs from the phase of the reactants. Therefore, in the present invention, a “homogeneous catalyst” is soluble in the electrochemical cell solution. In particular, the homogeneous catalysts of the invention are soluble in water.

As used herein, “conductive polymers” are understood as organic polymers that conduct electricity. In particular, polyacetylene, polypyrrole, polyaniline, poly(p-phenylene vinylene) (PPV), poly(3-alkylthiophenes) and their copolymers are the main classes of conductive polymers. Examples of conductive polymers are polyfluorenes, polyphenylenes, polypyrenes, polyazulenes, polynaphthalenes, poly(pyrrole)s (PPY), polycarbazoles, polyindoles, polyazepines, polyanilines (PANI), poly(thiophene)s (PT), poly(3,4-ethylenedioxythiophene) (PEDOT), and poly(p-phenylene sulfide) (PPS). Preferred conductive polymers are polypyrrole, polyazepines, polyanilines or poly(3,4-ethylenedioxythiophene). It may also be a polymer in which a conductive material, such as carbon powder is embedded.

As used herein, an “ionomer” is understood as a polymer that comprises monomer units of both electrically neutral monomer units and a fraction of ionized monomer units (usually no more than 15 mole percent) covalently bound to the polymer backbone as lateral moieties. Most ionomers are copolymers of neutral segments and ionized units, said ionized units usually consisting of carboxylic acid groups or sulfonic acid groups. Preferred examples of ionomers are polystyrene sulfonates, and in particular Nafion®, a sulfonated tetrafluoroethylene based fluoropolymer-copolymer.

As used herein, a “fluoropolymer” is understood as a fluorocarbon based polymer with multiple carbon-fluorine bonds. In particular, a fluoropolymer results from a polymerization reaction using at least one type of fluorinated monomer. It is characterized by a high resistance to solvents, acids, and bases. Examples of suitable fluoropolymers are polyvinylfluoride and polyethylenetetrafluoroethylene.

As used herein, a “conductive material” is understood as a material that conducts electricity. Preferred examples of conductive materials are conductive carbon materials, and in particular carbon powder and carbon nanotubes.

As used herein, “syngas” is understood as a mixture of H₂ and CO gas, in any proportion. However, syngas does not encompass pure H₂ or pure CO gas.

As used herein, an “electrolyte solution” comprises a solvent and a supporting electrolyte, which is preferably a salt.

As used herein, an “aqueous mixture” of an organic solvent is a mixture of said organic solvent with water.

As used herein, a “buffer” or “buffering agent” is a weak acid or base used to maintain the acidity (pH) of a solution near a chosen value after the addition of another acid or base. That is, the function of a buffering agent is to prevent a rapid change in pH when acids or bases (such as CO₂) are added to the solution. Examples of buffers are phosphate buffer (such as Na₂HPO₄ or Na₂HPO₄ or mixtures thereof) and carbonate buffer (such as KHCO₃).

### DETAILED DESCRIPTION

Porphyrins

First, the present invention concerns the iron complex of a porphyrin of formula (I) below:

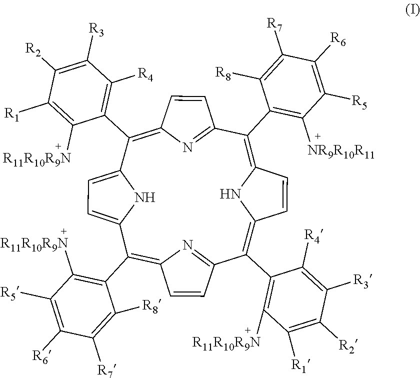

wherein R₁ to R₈ and R₁′ to R₈′ are independently selected from the group consisting of H, OH, F and C₁-C₆-alkyl,

provided that at least 2 of R₁-R₄ are H, at least 2 of R_{1′}-R_{4′} are H, at least 2 of R₅-R₈ are H, and at least 2 of R_{5′}-R₈′ are H, and

R₉, R₁₀ and R₁₁ are independently selected from a C₁-C₄-alkyl group,

and salts thereof.

The porphyrins of the invention may exist as different atropisomers. The present invention contemplates in particular all atropisomers, and mixtures thereof in all proportions.

Preferably, R₉, R₁₀ and R₁₁ are independently selected from a C₁-C₂-alkyl group, such as a methyl group.

In a particular embodiment, R₉, R₁₀ and R₁₁ are identical, and in particular are a methyl group.

R₁ to R₈ and R₁ to R₈′ are preferably independently selected from the group consisting of H, F and C₁-C₆-alkyl, preferably of H, F, even more preferably H and C₁-C₄-alkyl, most preferably H and methyl. Advantageously, at least 3 of R₁-R₄ are H, at least 3 of R_{1′}-R_{4′} are H, at least 3 of R₅-R₈ are H, and at least 3 of R_{5′}-R_{8′} are H.

In a particular embodiment, R₁, R₂, R₃, R₄, are respectively identical to R₁′, R₂′, R₃′, R₄′. In another particular embodiment, R₅, R₆, R₇, R₈, are respectively identical to R₅′, R₆′, R₇′, R₈′.

In another particular embodiment, R₁, R₂, R₃, R₄, R₅, R₆, R₇, R₈, are respectively identical to R₁′, R₂′, R₃′, R₄′, R₅′, R₆′, R₇′, R₈′.

In another particular embodiment, R₁′, R₂′, R₃′, R₄′ are respectively identical to R₁, R₂, R₃, R₄; R₅, R₆, R₇, R₈, are respectively identical to R₁, R₂, R₃, R₄; and R₅′, R₆′, R₇′, R_{8′} are respectively identical to R₁, R₂, R₃, R₄. In this embodiment, the porphyrin of the invention is of formula (Ia):

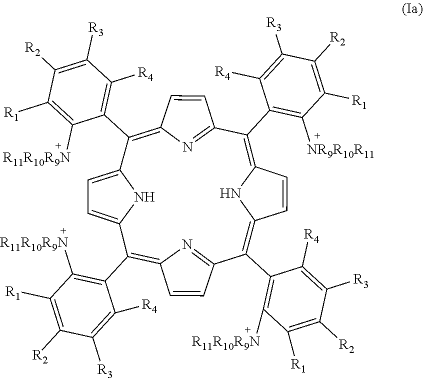

with R₁ to R₄ and R₉, R₁₀ and R₁₁ as defined above or below,

or atropisomers thereof, and salts thereof, in particular a halogen salt thereof, such as a bromide or a chloride salt or a trifluoromethanesulfonate salt.

Most preferably, the porphyrin of the invention is of formula (Ib):

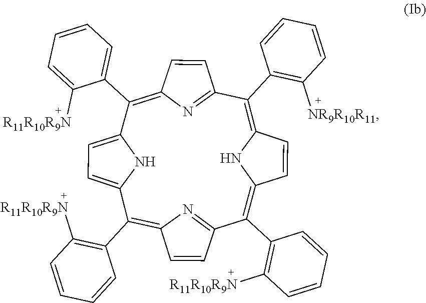

with R₉, R₁₀ and R₁₁ as defined above or below, or atropisomers thereof (in particular the α,β, α,β-atropisomer), and salts thereof, in particular a halogen salt thereof, such as a bromide or a chloride salt or a trifluoromethanesulfonate salt.

Preferably, R₉, R₁₀ and R₁₁ are independently selected from a C₁-C₂-alkyl group, such as a methyl group.

In a particular embodiment, R₉, R₁₀ and R₁₁ are identical.

For example, the iron complex of the invention is the iron complex of the following porphyrin:

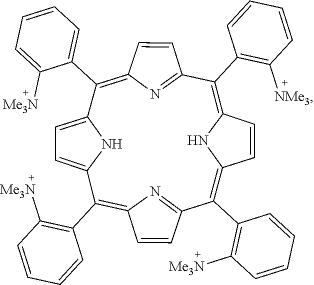

or atropisomers thereof, and salts thereof, in particular a halogen salt thereof, such as a bromide or a chloride salt thereof (in particular the tetrachloride salt).

Of note, the iron complex of

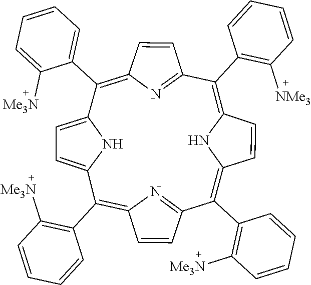

(especially as the trifluoromethanesulfonate salt) is referred to as Fe-o-TMA throughout the present description.

The metal transition complexes of the porphyrins of formula (I) are prepared according to methods well-known in the art (see in particular Costentin et al Proc. Natl. Acad. Sci. U.S.A. 2014, 111, 14990-14994).

The iron complexes of the invention may for instance be obtained from the corresponding tetra-o-nitro substituted porphyrins, which are then reduced to the corresponding tetra-o-amino substituted porphyrins. Said tetra-o-amino substituted porphyrins may then be alkylated (with C₁-C₆ alkyl groups or C₁-C₆ alkylaryl groups) to give the corresponding tetra-o-NR₉R₁₀ substituted porphyrins, which is then subjected to complexation with an iron salt such as Fe(II)X₂, with X representing a halogen such as bromide or chloride (preferably bromide), to yield the corresponding tetra-o-NR₉R₁₀ substituted porphyrins iron complex. Alternatively, complexation with iron may be carried out first under the same reaction conditions, and alkylation of the free amine may then be effected as described above. Finally, the neutral complex is alkylated (with C₁-C₆ alkyl groups or C₁-C₆ alkylaryl groups) to form the corresponding porphyrin of formula (I) containing four ortho-anilinium groups.

Of note, the complex is typically isolated as the Fe(III) complex, and more particularly as the Fe(III)Cl complex of the corresponding porphyrin of formula (I), where appropriate as a salt such as the chloride salt (in particular the tetrachloride salt). The active Fe(O) species (active Fe(O) complex for the reduction of CO₂ into CO) is generated in situ in the reaction medium (in particular in the electrochemical cell) from the Fe(III) complex. Therefore, in the present invention, CO₂ is reduced into CO by the porphyrin of formula (I) with Fe(0) (iron at the oxidation state of 0).

Therefore, the electrochemical reduction of CO₂ into CO with the catalyst of the invention typically involves the Fe(0), Fe(I), Fe(II) and Fe(III) complexes of the porphyrins of formula (I) as defined above.

Use as Catalyst

The present invention further relates to the use of the iron complex of the invention as catalyst for the electrochemical reduction of CO₂ into CO.

In other words, the present invention relates to a method of electrochemically reducing CO₂ into CO, comprising using the iron complex of the invention as catalyst.

In a particular embodiment, the iron complex of the invention is used for catalyzing the electrochemical reduction of CO₂ into CO in an organic solvent, such as such as DMF (dimethylformamide), ACN (acetonitrile), and aqueous mixtures thereof. In this embodiment, the electrolytes organic solvent further comprises a proton donor, advantageously with a pKa value in DMF of between 18 and 31, in particular selected from the group consisting of water (H₂O), trifluoroethanol, phenol and acetic acid, advantageously H₂O or phenol. Advantageously, when a proton donor is used, said proton donor is used in a concentration of between 100 mM and 5M, preferably between 100 mM and 3M, even more preferably between 1M and 3M. In some embodiments, the electrolyte solvent is a solution of phenol or water in DMF, preferably 0.0-5.0 M solution of water or phenol in DMF, more preferably 0.0-2.5 M solution of water or phenol in DMF, even more preferably 1.0-2.0 M solution of water or phenol in DMF, and may contain additives (in particular supporting electrolytes) such as salts.

In another particular embodiment, the complex of the invention is used for catalyzing the electrochemical reduction of CO₂ into CO in water. In this case, the electrolyte solvent preferably consists in water and a supporting electrolyte. In other words, in this embodiment, the electrolyte solvent preferably does not contain any organic solvent, be it as co-solvent or proton-donor.

Depending on the experimental conditions, H₂ production may be promoted, and syngas may be produced.

In the present invention, the electrochemical reduction of CO₂ into CO is particularly selective. In particular, no formation of formic acid or formate is observed, while CO or syngas is produced.

Advantageously, in the present invention, the electrochemical reduction of CO₂ into CO is carried out at a CO₂ pressure of at least 1 bar such as between 1 and 30 bars. In a particular embodiment, the electrochemical reduction of CO₂ into CO is carried out at a CO₂ pressure of 1 bar (atmospheric pressure), preferably only in the cathodic compartment. In another embodiment, the electrochemical reduction of CO₂ into CO is carried out at a CO₂ pressure of more than 1 bar, for instance of between 2 and 30 bars, preferably only in the cathodic compartment.

In one embodiment, the iron complex of the invention is used as homogenous catalysts.

In another embodiment, the iron complex of the invention is used as immobilized catalyst (for heterogeneous catalysis). In this embodiment, the catalyst is preferably immobilized on at least one electrode (preferably the cathode) using a binder. Therefore, in this embodiment, at least one electrode (preferably the cathode) comprises a composition comprising the catalyst and a binder. Advantageously, the composition is coated as a film on the electrode.

Advantageously, the binder is selected from the group consisting of conductive polymers, ionomers and/or fluoropolymers preferably a fluorinated polymer with sulfonic end groups such as a perfluorosulfonic acid. Preferred examples of binders are ionomers such as polystyrene sulfonates, and in particular Nafion®, a sulfonated tetrafluoroethylene based fluoropolymer-copolymer.

Advantageously, conductive materials are added to the binder to improve the conductivity of the system. Preferred examples of conductive materials are conductive carbon materials, and in particular carbon powder and carbon nanotubes.

Electrochemical Cell

The present invention further relates to an electrochemical cell comprising at least:
at least one electrolyte solution comprising a solvent and a supporting electrolyte such as a salt (preferably a mixture of alkali metal, such as hydroxide, carbonate, bicarbonate or chloride alkali metal salts), and the substrate CO₂,
a power supply providing the energy necessary to trigger the electrochemical reactions involving the substrate, and
two electrodes (an anode and a cathode),

and further comprising the iron complex of the invention.

In the electrochemical cell, the iron complex of the invention is used as catalyst for the electrochemical reduction of CO₂ into CO.

The particular and preferred embodiments of the porphyrin of formula (I) and the iron complex thereof are as described above.

The electrochemical cell of the invention comprises several compartments, in particular two compartments (the cathodic compartment comprising the cathode, and the anodic compartment comprising the anode), advantageously separated by a proton exchange membrane comprising or consisting of a ionomer or/and fluoropolymer, preferably a fluorinated polymer with sulfonic end groups such as a perfluorosulfonic acid.

In a preferred embodiment, the electrochemical cell of the invention comprises at least:
a cathodic compartment with a cathode and a cathodic electrolyte solution comprising a cathodic solvent and a cathodic supporting electrolyte such as a salt, preferably a mixture of alkali metal (such as hydroxide, carbonate, bicarbonate or chloride alkali metal salts), and the substrate CO₂,
an anodic compartment with an anode and an anodic electrolyte solution comprising a solvent and an anodic supporting electrolyte,
a power supply providing the energy necessary to trigger the electrochemical reactions involving the substrate,

and further comprising the iron complex of a porphyrin of formula (I) as defined above.

In a particular embodiment, the electrochemical cell of the invention is saturated with CO₂ gas, that is to say, both the atmosphere and the electrolyte solution are saturated with CO₂.

The electrochemical cell of the invention may be used as a closed system regarding CO₂ gas. This embodiment is of particular interest when the electrochemical cell of the invention is used to study the catalytic mechanism of the reduction of CO₂ into CO, as such a configuration allows for a tight control of gas evolution.

Conversely, the electrochemical cell of the invention may be used in an open environment, with a flow of CO₂ which saturates the electrolyte and solvent of the electrochemical cell of the invention. This configuration is particularly useful when industrial production of CO or syngas is sought for.

It is noteworthy that CO is typically not soluble in the electrolyte solution, so that it is collected directly as a gas.

Advantageously, CO₂ gas is present only in the cathodic compartment and the CO₂ pressure in the cathodic compartment of the electrochemical cell of the invention is of at least 1 bar. In a particular embodiment, the CO₂ pressure in the electrochemical cell of the invention is of 1 bar (atmospheric pressure), preferably only in the cathodic compartment. In another embodiment, the CO₂ pressure in the electrochemical cell of the invention (preferably only in the cathodic compartment) is of more than 1 bar, for instance of between 2 and 30 bars.

The power source may comprise one or more of power supplies (e.g., batteries and a photovoltaic cell).

Preferably, the anode is a carbon, iridium oxide, cobalt oxide, cobalt phosphate, stainless steel or platinum electrode, for example it is a carbon, iridium oxide, cobalt oxide or platinum electrode. More preferably, the anode is an iridium oxide, cobalt oxide, cobalt phosphate or platinum electrode, and even more preferably it is an iridium oxide, cobalt oxide or platinum electrode.

Advantageously, the cathode is a carbon, stainless steel or mercury electrode.

Preferably, it is a carbon electrode or a stainless steel electrode. More preferably, it is a carbon electrode such as a carbon crucible, carbon felt or carbon paper.

In a particular embodiment, the electrochemical cell further comprises a third electrode, preferably a reference electrode such as a standard calomel electrode or a silver chloride electrode.

The solvent of the electrolyte solutions is preferably selected from DMF (dimethylformamide), ACN (acetonitrile), water (H₂O) or mixtures thereof. When the solvent comprises DMF (dimethylformamide) and/or ACN (acetonitrile), said solvent advantageously further comprises a proton donor, preferably with a pKa value in DMF of between 18 and 31, in particular selected from the group consisting of water (H₂O), trifluoroethanol, phenol and acetic acid, advantageously H₂O or phenol.

The electrolyte solutions are preferably aqueous solutions with a pH of between 6.5 and 7.5.

The supporting electrolyte of the invention comprises or consists of salts, in particular organic and inorganic salts and mixtures thereof. The salts may include buffers.

In a particular embodiment, the solvent of the anodic and cathodic electrolyte solution is identical. In this embodiment, the cathodic and anodic supporting electrolytes are identical or different. For instance, the cathodic supporting electrolyte is devoid of buffer, and the anodic supporting electrolyte comprises a phosphate buffer. The cathodic electrolyte may in particular consist of an aqueous solution of alkali metal salts, preferably chloride and carbonate salts, or mixtures thereof.

The anodic supporting electrolyte may comprise a buffer, preferably an alkali metal salt, and more preferably a mixture of KH₂PO₄ (monopotassium phosphate) and K₂HPO₄ (dipotassium phosphate) in an overall concentration of between 0.01 M and 1 M, more preferably of between 0.1 M and 0.6 M, and even more preferably of 0.4 M in the solvent.

In addition, in a preferred embodiment, CO₂ is present only in the cathodic compartment, and is thus partially dissolved in the cathodic electrolyte solution, while the anodic electrolyte solution is devoid of dissolved CO₂, as well as HCO₃⁻ and HCO₃²⁻ anions.

When production of pure CO in water is sought for, the pH of the cathodic and of the anodic electrolyte solution is preferably of between 6.5 and 7.5 in each compartment.

Advantageously, the pH of the cathodic and of the anodic electrolyte solution is identical. In addition, the cathodic electrolyte solution is preferably devoid of any buffer. In particular, the cathodic electrolyte does not contain any phosphate buffer.

When production of syngas is sought for, the cathodic electrolyte may contain a buffer such as phosphate buffer.

In a particular embodiment, the catalyst is immobilized on at least one electrode (preferably the cathode) using a binder. Therefore, in this embodiment, at least one electrode (preferably the cathode) comprises a composition comprising the catalyst and a binder. Advantageously, the composition is coated as a film on the electrode.

Advantageously, the binder is selected from the group consisting of conductive polymers, ionomers and/or fluoropolymers preferably a fluorinated polymer with sulfonic end groups such as a perfluorosulfonic acid. Preferred examples of binders are ionomers such as polystyrene sulfonates, and in particular Nafion®, a sulfonated tetrafluoroethylene based fluoropolymer-copolymer. This embodiment is of particular interest because of the complementary nature of the ionic charges of the complexes used in the invention (positively charged anilinium groups) and of the binder (negatively charged sulfonic groups). Advantageously, conductive materials are added to the binder to improve the conductivity of the system. Preferred examples of conductive materials are conductive carbon materials, and in particular carbon powder and carbon nanotubes. Said binder ensures: 1) a good conductivity, as well as 2) a good permeation of protons, CO₂ and CO through the composition by means of porosity of the polymer and/or the presence of acid-base functional groups within the polymer structure.

In another particular embodiment, the catalyst of the invention is used as a homogenous catalyst. In this case, the iron complex of the porphyrin of formula (I), as defined above, is in a concentration, in the electrolyte solution, of between 0.0001 and 0.01 M, preferably 0.001 M.

### First Embodiment: Water as Solvent of the Electrolyte Solutions

In a first embodiment, the solvent of the cathodic and anodic electrolyte solutions is water.

Advantageously, in this embodiment, the cathodic supporting electrolyte is devoid of any buffer other than carbonate buffer. In particular, it is devoid of phosphate buffer.

For instance, the cathodic supporting electrolyte is devoid of buffer, and the anodic supporting electrolyte comprises a phosphate buffer. The cathodic electrolyte may in particular consist of an aqueous solution of alkali metal salts, preferably chloride and carbonate salts, or mixtures thereof. Advantageously, the cathodic supporting electrolyte may consist of a mixture of KCl (potassium chloride), preferably in a concentration of between 0.001 M and 1M, more preferably of 0.1M and KHCO₃ (potassium bicarbonate), preferably in a concentration of between 0.01 and 1M, more preferably of between 0.1M and 0.5M in the solvent. The anodic supporting electrolyte may comprise a buffer, preferably an alkali metal salt, and more preferably a mixture of KH₂PO₄ (monopotassium phosphate) and K₂HPO₄ (dipotassium phosphate) in an overall concentration of between 0.01 M and 1 M, more preferably of between 0.1 M and 0.6 M, and even more preferably of 0.4 M in the solvent.

In this embodiment, the catalyst is preferably immobilized as described above, for instance on at least one electrode (preferably the cathode) using a binder, optionally comprising a conductive material as described above.

### Second Embodiment: Organic Medium as Solvent of the Electrolyte Solutions

In a second embodiment, the solvent of the cathodic and anodic electrolyte solutions is an organic medium, such as DMF (dimethylformamide), ACN (acetonitrile), and aqueous mixtures thereof. Advantageously, the electrolyte solutions comprise DMF (dimethylformamide) or ACN (acetonitrile) as the solvent. The electrolyte solution may further contain salts as the supporting electrolyte, such as n-NBu₄PF₆ for example. The electrolyte solution may further contain additives such as n-NBu₄ oxalate (tetrabutylammonium oxalate) for instance.

Preferably, the electrolyte solutions further comprise a proton donor, advantageously with a pKa value in DMF of between 18 and 31, in particular selected from the group consisting of water (H₂O), trifluoroethanol, phenol and acetic acid, advantageously H₂O or phenol. Advantageously, when a proton donor is used, said proton donor is used in a concentration of between 100 mM and 5M, preferably between 100 mM and 3M, even more preferably between 1M and 3M. In some embodiments, the electrolyte solutions are solutions of phenol or water in DMF, preferably 0.0-5.0 M solutions of water or phenol in DMF, more preferably 0.0-2.5 M solutions of water or phenol in DMF, even more preferably 1.0-2.0 M solutions of water or phenol in DMF, and may contain additives (in particular supporting electrolytes) such as salts.

Preferably, the solvent is DMF and the electrolyte solution (preferably the cathodic electrolyte solution, and optionally the anodic electrolyte solution) further comprises at least a proton donor, preferably selected from the group consisting of water (H₂O), trifluoroethanol, phenol and acetic acid, even more advantageously H₂O or phenol.

In this second embodiment, the catalyst is preferably homogeneous, i.e. it is solubilized into the electrolyte solution, and it is preferably in a concentration of between 0.0001 and 0.01 M, preferably 0.001 M in the electrolyte solution.

The catalyst may however be immobilized as described above, for instance on at least one electrode (preferably the cathode) using a binder.

Use of the Electrochemical Cell

The present invention further concerns a method comprising performing the electrochemical reduction of CO₂ using the electrochemical cell of the present invention, thereby producing CO gas or syngas in water.

The potential applied to the cathode vs NHE is preferably of between −2.5 V and −0.5 V versus NHE. In this embodiment, the current density of the cathode is typically below 30 A/m², in particular below 5 A/m².

The method of the invention allows production of CO or syngas, depending on the reaction conditions (in particular depending on the pH of the electrolyte solutions, on the presence of buffer in the cathodic electrolyte solution, and on the potential applied to the cathode). The method of the invention produces only minimal amounts of undesired byproducts. No formation of formic acid or formate is observed, in particular when production of pure CO is sought for.

The faradic yield of CO is thus advantageously of between 80% and 100%. When CO is selectively produced, The faradic yield of CO is preferably of between 90% and 100%, more preferably of 95% and 100%, in particular depending on the potential applied to the cathode.

When syngas is produced, the faradaic yield of H₂ is typically of between 0.5% and 20%, in particular of between 1% and 10%, for instance 2% to 7%.

When a mixture of CO and H₂ (syngas) is produced, in particular the pH of the aqueous solution and the potential applied to the cathode are adjusted so as to tune the CO/H₂ molar ratio of the produced gas

### First Embodiment: Water as Solvent of the Electrolyte Solutions

In a first embodiment, the solvent of the cathodic and anodic electrolyte solutions is water.

When syngas is produced in this embodiment, the pH of the cathodic electrolyte solution (notably through appropriate choice of buffer) and the potential applied to the cathode may be adjusted so as to tune (or choose) the CO/H₂ molar ratio of the produced gas. In this case, the cathodic electrolyte solution preferably comprises a buffer such as a phosphate buffer. The pH of the cathodic electrolyte solution is also typically of between 6.5 and 7.5.

For producing pure CO, the pH of the cathodic electrolyte solution is preferably of between 6.5 and 7.5, and the cathodic electrolyte solution is advantageously devoid of buffer, in particular it is devoid of phosphate buffer. In this embodiment, the pH of the cathodic electrolyte solution is advantageously adjusted by adding alkali metal salts, preferably hydroxide, carbonate or bicarbonate alkali metal salts, more preferably KOH or KHCO₃, even more preferably KHCO₃. Preferably, in this embodiment, the potential applied to the cathode vs NHE is of between −1.5 V and −0.7 V versus NHE such as −1.25V and −1.0V, more preferably between −1.21 V and −1.05V, even more preferably of −1.1V. More preferably, in this embodiment, the potential applied to the cathode vs NHE is of between −1.15V and −0.75V, more preferably between −1.1 V and −0.85V, even more preferably of −0.96V. In this embodiment, the current density of the cathode is typically below 30 A/m², in particular below 1 A/m².

### Second Embodiment: Organic Medium as Solvent of the Electrolyte Solutions

In a second embodiment, the solvent of the cathodic and anodic electrolyte solutions is an organic medium, such as DMF (dimethylformamide), ACN (acetonitrile), and aqueous mixtures thereof. Preferably, the electrolyte solutions further comprise a proton donor as described above.

Advantageously, the intensity applied to the cathode is between 2 and 5 A/m², more preferably between 2.5 and 4 A/m², even more preferably between 3 and 3.5 A/m².

Advantageously, the potential applied to the cathode is between −2.5 V and −0.5 V versus NHE, more advantageously between −2.0 V and −0.5 V versus NHE, more advantageously between −1.5 V and −0.8 V versus NHE, more advantageously between −1.3 V and −0.9 V versus NHE, and the intensity applied to the cathode is advantageously between 2 and 5 A/m², more preferably between 2.5 and 4 A/m², even more preferably between 3 and 3.5 A/m².

### DESCRIPTION OF THE DRAWINGS

FIG. 1 represents the synthetic schema of Fe-o-TMA as used in example 1.

FIG. 2 represents cyclic voltammograms of the iron porphyrins Fe-o-TMA, Fe-p-TMA, Fe-p-PSULF, FeTPP, FeF5TPP, FeF10TPP and FeF20TPP (see below) in the potential domain of the catalytic CO₂ reduction wave in DMF+0.1 M n-Bu₄NPF₆+0.1 M H₂O+3 M PhOH, at 0.1V/s under 1 atmosphere of CO₂ The current, i, is normalized against the peak current of the reversible one-electron Fe^{II}/Fe^{I} reversible wave, iₚ⁰ obtained at the same scan rate (0.1 V/s). The abscissa axis represents the potential applied to the cathode vs SHE (in V), and the ordinate axis represents the normalized current.

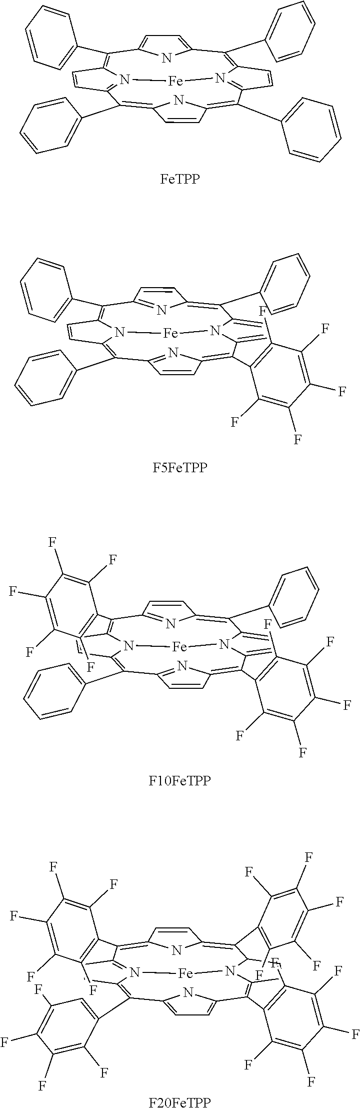

FIG. 3. Cyclic voltammetry of Fe-o-TMA, Fe-p-TMA and Fe-p-PSULF (concentration: 1 mM) in DMF+0.1 M n-Bu₄NPF₆+0.1 M H₂O at 0.1 V/s under argon (grey) and under 1 atm. CO₂ in the presence of 3 M PhOH (black). The bottom figures are a blow-up of the upper figures showing the formation of CO on the reverse scan (see example 2). The current axis is normalized toward the peak current iₚ⁰ of a one-electron reversible wave at the same concentration at same scan rate (0.1 V/s) as can be obtained from the Fe^{II/I} wave. The abscissa axis represents the potential applied to the cathode vs SHE (in V), and the ordinate axis represents the normalized current.

FIG. 4. Elimination of the secondary phenomena by raising the scan rate (see Example 2). Cyclic voltammetry of the substituted iron porphyrins (conc.: 1 mM) in DMF+0.1 M n-Bu₄NPF6+0.1 M H₂O under 1 atm. CO₂ in the presence of 3M PhOH at scan rates (V/s), from bottom to top: Fe-p-TMA: 0.1, 1, 5, 10; Fe-p-PSULF: 0.1, 1, 2; Fe-o-TMA: 0.1, 0.5, 1, 2, 6, 10, 20, 30, 48, 96, 115. The current, i, is normalized against the peak current of the reversible one-electron Fe^{II}/Fe^{I} reversible wave, iₚ⁰ obtained at 0.1 V/s. The abscissa axis represents the potential applied to the cathode vs SHE (in V), and the ordinate axis represents the normalized current.

FIG. 5. a: Catalytic Tafel plots of Fe-o-TMA, Fe-p-TMA, Fe-p-PSULF, FeTPP, FeF5TPP, FeF10TPP and FeF20TPP. b: correlation between TOFₘₐₓ=k_{cat} and E_{cat}⁰, recalling the through-structure substituents effect and showing the coulombic interaction effects of positively and negatively charged substituents, including the huge gain in reactivity and overpotential brought about by positively charged substituents when located in ortho position of the phenyl ring.

FIG. 6. depicts the benchmarking of all catalysts based on catalytic Tafel plots derived from cyclic voltammetry experiments in DMF or acetonitrile (see Costentin et al Proc. Natl. Acad. Sci. U.S.A. 2014, 111, 14990-14994 for details and references). The abscissa axis represents the overpotential η (in Volts), and the ordinate axis represents log(TOF).

See example 3 for experimental details.

a: example 3; b: in the presence of 3M PhOH, c: see structure above.

py=pyridine, tpy=2,2′:6′,2″-terpyridine, bpy=2,2′-bipyridine, Mebimpy=2,6-bis(1-methyl benzimidazol-2-yl)pyridine

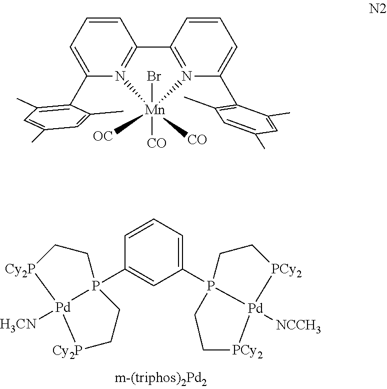

The vertical arrows indicate the overpotential values at which the electrolysis were carried out (see text and FIG. 8).

FIG. 7. Preparative-scale electrochemical CO₂-to-CO conversion catalyzed by Fe-p-TMA (at an overpotential of 450 mV, vertical arrow in FIG. 7) and Fe-o-TMA (at an overpotential of 220 mV, vertical arrow in FIG. 7) in DMF+0.1 M n-Bu₄NPF₆+0.1 M H₂O under 1 atm. CO₂ in the presence of 3M PhOH (catalyst conc.: 0.5 mM). CO (full circle) and H₂ (open circle) faradaic yields (top) and CO-vs-H₂ selectivity (bottom), defined as: % CO/(% CO+% H₂).

FIG. 8. Long run (84 hours) preparative-scale electrochemical CO₂-to-CO conversion catalyzed by Fe-o-TMA (at an overpotential of 220 mV, vertical arrow in FIG. 7) in DMF+0.1 M n-Bu₄NPF₆+0.1 M H₂O under 1 atm. CO₂ in the presence of 3 M PhOH (catalyst concentration: 0.5 mM). a. Charge evolution and b. Faradaic yields (CO: full symbols, H₂: open symbols) as a function of time during 24 h on a carbon electrode (circles), then 18 h on a mercury electrode (squares), then a second 18 h period again on a mercury electrode (diamonds) and finally another 24 h period again on a carbon electrode (triangles).

a. The abscissa axis represents the time (in hours), and the ordinate axis represents the charged passed (in Coulomb). b. The abscissa axis represents the time (in hours), and the ordinate axis represents the faradaic yield (in %).

FIG. 9. Cyclic voltammetry of Fe-p-TMA, and Fe-p-TMA (concentration: 0.5 mM) in H₂O+0.1 M KCl at 0.1 V/s under argon (grey) and under 1 atm. CO₂+0.5M KHCO₃ (black) at pH 7.1. The bottom figures are a blow-up of the upper figures. The abscissa axis represents the potential applied to the cathode vs SHE (in V), and the ordinate axis represents the current (in μA).

FIG. 10. Long run (60 hours) preparative-scale electrochemical CO₂-to-CO conversion catalyzed by Fe-o-TMA (at an applied potential of −0.86V, −0.91V and −0.96V vs. NHE) in H₂O+0.1 KCl+0.5M KHCO₃ under 1 atm. CO₂ (catalyst concentration: 0.5 mM). Left ordinate axis represents the charge evolution (in Coulomb) and right ordinate axis represents the selectivity for CO (black squares) and H₂ (open circles) (in %) as a function of time during 60 h on a carbon electrode.

FIG. 11. Preparative-scale electrochemical CO2-to-CO conversion catalyzed by Fe-p-TMA (at an applied potential of −0.96V vs. NHE, grey line) and Fe-o-TMA (at an applied potential of −086V, −0.91V and −0.96V vs. NHE, black line) in H₂O+0.1 KCl+0.5M KHCO₃ under 1 atm. CO₂ (catalyst concentration: 0.5 mM). CO (red dotsfull circle) and H₂ (blue open dotscircle) faradaic yields (top) and CO-vs-H₂ selectivity (bottom), defined as: % CO/(% CO+% H₂). The abscissa axis represents the time (in hours), and the ordinate axis represents the current (in mA).

### EXAMPLES

The following examples, while relating to particular embodiments of the invention, are intended for purposes of illustration only and are not intended to limit the scope of the invention.

As used herein, “TOF₀” represents the TurnOver Frequency at zero overpotential. The value of TOF₀ is obtained from extrapolation of the TOF vs. overpotential curve at zero overpotential. The TOF vs. overpotential curve is obtained from the experimental measurement of the current density (I) as function of potential (E) using cyclic voltammetry. For example, in the case of a simple mechanism (i.e. if the chemical steps in the catalytic loop are equivalent to a single step characterized by an apparent catalytic constant) the following relationship can be used:

$$TOF = \frac{I}{F \sqrt{\frac{D}{{k}_{cat}}} {C}_{cat}^{0}}$$

with D being the diffusion coefficient of the catalyst, C_{cat}⁰ at being its concentration in solution and k_{cat} the catalytic rate constant. The value of TOF₀ is preferably obtained from extrapolation of the TOF vs. overpotential curve at zero overpotential. Said TOF vs. overpotential curve is for instance obtained such as described in Costentin et al ChemElectroChem, 2014, 1, 1226-1236, or calculated as detailed in Costentin et al, Science 2012 338, 90.

### Example 1. Synthesis and Characterization of Fe-o-TMA

Chemicals.

Dimethylformamide (Acros, >99.8%, extra dry over molecular sieves), the supporting electrolyte NBu₄PF₆ (Fluka, purriss.) were used as received. All starting materials were obtained from Sigma-Aldrich, Fluka, Acros and Alfa-Aesar, and were used without further purification. CHCl₃ and CH₂Cl₂ were distilled from calcium hydride and stored under an argon atmosphere.

Materials.

¹H NMR spectra were recorded on a Bruker Avance III 400 MHz spectrometer and were referenced to the resonances of the solvent used. The mass spectra were recorded on a MALDI 4800 TOF/TOF. The elemental analysis were performed by the Microanalysis Service of the Institut de Chimie des Substances Naturelles (ICSN-CNRS), Avenue de la Terrasse, 91198 Gif-sur-Yvette cedex, France.

Porphyrins.

Iron(III) 5,10,15,20-tetrakis(4′-N,N,N-trimethylanilinium)-porphyrin pentachloride (Fe-p-TMA) was prepared as described elsewhere in Costentin et al. (Proc. Natl. Acad. Sci. U.S.A., 2015, 112, 6882).

Chloro iron(III) 5,10,15,20-tetrakis(4-sulfonatophenyl)porphyrin (tetrabutylammonium salt form) (Fe-p-PSULF) was prepared in situ by the deprotonation of commercial Chloro iron(III) 5,10,15,20-tetrakis(4-sulfonatophenyl)porphyrin (acid form) (LivChem Logistic) with 4 eq. of TBAOH.

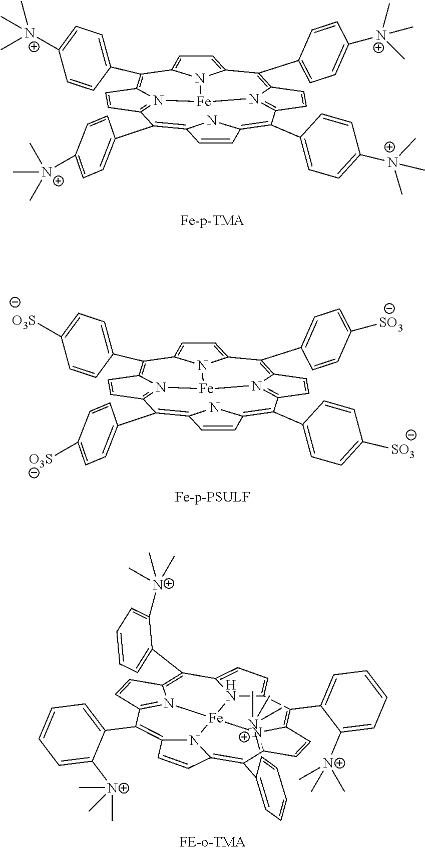

### Synthesis of Chloro iron(III) 5,10,15,20-tetra-(o-N,N,N-trimethylanilium)-porphyrin tetra trifluoromethanesulfonate (Fe-o-TMA)

### 5,10,15,20-tetra(o-nitrophenyl)-21H,23H-porphyrin. (1)

Compound 1 was synthesized following a previously reported procedure by Collman et al. (J. Am. Chem. Soc. 1975, 97, 1427-1439).

Pyrrole (4.62 mL; 66.17 mmol, 1 eq) was added dropwise to a solution of 2-nitrobenzaldehyde (10 g, 66.2 mmol, 1 eq.) in boiling acetic acid (200 mL). After 20 min of stirring at reflux, the solution was cooled in an ice bath and chloroform (25 mL) was added. The mixture was filtered on a glass frit and the purple powder was thoroughly washed with chloroform and methanol until filtrates were colorless. The product was recovered and dried in the oven (1.8 g, 13.6%)

### α,β-5,10,15,20-tetra(o-aminophenyl)-21H,23H-porphyrin. (2)

Compound 2 was synthesized following a previously reported procedure by Collman et al. (J. Am. Chem. Soc. 1975, 97, 1427-1439).

Porphyrin 1 (1.8 g; 2.265 mmol, 1 eq.) was dissolved in concentrated HCl solution (60 mL). Excess SnCl₂.2H₂O (7.67 g; 34 mmol, 15 eq.) was added, and the mixture quickly heated at 70° C. for 25 min. After careful neutralization with ammonia, chloroform was added and the red mixture was stirred vigorously for 1 h. The organic phase was kept, and the aqueous phase was extracted with chloroform 3 times. The organic phases were combined, filtered, reduced under vacuum, washed with dilute ammonia and water, dried on Na₂SO₄ and evaporated, affording a statistical mixture of the 4 atropisomers of the desired product with impurities (1.86 g).

Pure α,β,α,β-5,10,15,20-(o-aminophenyl)-21H,23H-porphyrin can be obtained after purification by column chromatography on silica gel (gradient elution from CH₂Cl₂/Et₂O=100/0 to 95/5). The others atropisomers can be recovered after elution of CH₂Cl₂/MeOH 90/10. Refluxing the 3 others atropisomers in toluene for 4 h affords a new statistical mixture of 5,10,15,20-(o-aminophenyl)-21H, 23H-porphyrin.

¹H NMR (400 MHz, CDCl₃) δ 8.91 (s, 8H, β-H), 7.88 (dd, J=7.4, 1.4 Hz, 4H, Ar—H), 7.60 (td, J=8.0, 1.5 Hz, 4H, Ar—H), 7.17 (td, J=7.4, 1.1 Hz, 4H, Ar—H), 7.11 (dd, J=8.1, 0.8 Hz, 4H, Ar—H), 3.51 (s, 8H, Ar—NH₂), −2.67 (s, 2H, Pyr-NH).

HR-MALDI-TOF ([M+H+]⁺) calculated for C₄₄H₃₅N₈: 675.2980, found: 675.3359 IR (cm⁻¹): 3464w, 3359w, 3317w, 2920w, 2855w, 1613m, 1491m, 1472m, 1449m, 1348w, 1297m, 1261w, 1213w, 1185w, 1158w, 965s, 800s, 741vs, 648s

### Chloro iron(III) α,β,α,β-5,10,15,20-tetra(o-aminophenyl)-porphyrin. (3)

A solution of 2 (165 mg; 0.245 mmol; 1 eq.) and 2,6-lutidine (0.57 mL; 4.89 mmol; 20 eq.) in freshly distilled THF (50 mL) is degassed with argon for 10 min. FeBr₂ (500 mg; 1.69 mmol; 6.9 eq.) is added and the reaction mixture is stirred for 4 hours under argon. After evaporation in vacuo, the residue is solubilized in CH₂Cl₂ and washed with water (until aqueous phase gets colorless) and with saturated NaCl solution. The organic phase is then dried overs MgSO₄, filtered, evaporated and purified by column chromatography on silica gel (gradient elution from CH₂Cl₂/MeOH=100/0 to 90/10) affording the desired product as a purple powder (185 mg) in 98% yield.

HR-MALDI-TOF ([M−Cl⁻]⁺) calculated for C₄₄H₃₂FeN₈: 728.2094, found: 728.1423 UV-vis (DMF, λₘₐₓ/nm, log(ε)/L·mol⁻¹·cm⁻¹): 414 (4.84), 576 (3.92), 626 (3.55) IR (cm⁻¹): 3464w, 3359w, 3204vw, 2916vw, 1612m, 1576m, 1495m, 1450m, 1334w, 1299m, 1267vw, 1201w, 1157w, 1067w, 997vs, 860w, 802m, 748s, 721m

### α,β,α,β-5,10,15,20-tetra(o-N,N-dimethylaminophenyl)-21H,23H-porphyrin (5)

To a solution of porphyrin 2 (170 mg; 0.25 mmol; 1 eq.) in MeCN/MeOH (2/4 mL) is added formaldehyde (37% in H₂O; 750 μL; 10.1 mmol; 40 eq.) and sodium cyanoborohydride (79.2 mg; 1.26 mmol; 5 eq.). Glacial acetic acid (4.5 mL) is then poured dropwise and the reaction mixture is stirred for 4 hours at room temperature. The reaction mixture is diluted with CH₂Cl₂ (20 mL) and cautiously washed with saturated Na₂CO₃ solution (2×30 mL) and water (1×30 mL). The organic phase is dried over Na₂SO₄, evaporated in vacuo and the residue is purified by column chromatography on silica gel (gradient elution from Petroleum ether/Ethyl acetate=100/0 to 90/10) affording the desired product as a purple powder (112 mg) in 57% yield.

¹H NMR (400 MHz, CDCl₃) δ 8.75 (s, 8H, β-H), 7.99 (dd, J=7.4, 1.6 Hz, 4H, Ar—H), 7.76-7.64 (m, 4H, Ar—H), 7.40 (d, J=7.5 Hz, 4H, Ar—H), 7.30 (td, J=7.4, 1.0 Hz, 4H, Ar—H), 2.23 (s, 24H, N—CH₃), −2.30 (s, 2H Pyr-NH).

¹³C NMR (101 MHz, CDCl₃) δ 154.25 (C_{q}Ar—NMe₂), 137.66 (CH_{Ar}), 134.45 (C_{q}), 131.04* (CH_{β}), 129.20 (CH_{Ar}), 120.06 (CH_{Ar}), 118.62 (C_{q}), 117.91 (CH_{Ar}), 43.55 (N(CH₃)₂) *. *Broad signal for C_{β} and C_{α} could not be detected.

HR-MALDI-TOF ([M+H+]⁺) calculated for C₅₂H₅₁N₈: 787.4232, found: 787.4155.

UV-vis (DMF, ×ₘₐₓ/nm, log(ε)/L·mol⁻¹·cm⁻¹): 429 (5.20), 527 (4.21), 563 (3.88), 603 (3.78), 660 (3.61)

IR (cm⁻¹): 3314vw, 2924w, 2855w, 2787w, 1714vw, 1591w, 1558w, 1493m, 1472m, 1449m, 1429m, 1345m, 1316w, 1217m, 1158m, 1098w, 1050m, 967s, 945s, 801vs, 758s, 724vs

### Chloro iron(III) α,β,α,β-5,10,15,20-tetra(o-N,N-dimethylaminophenyl)-porphyrin. (4)

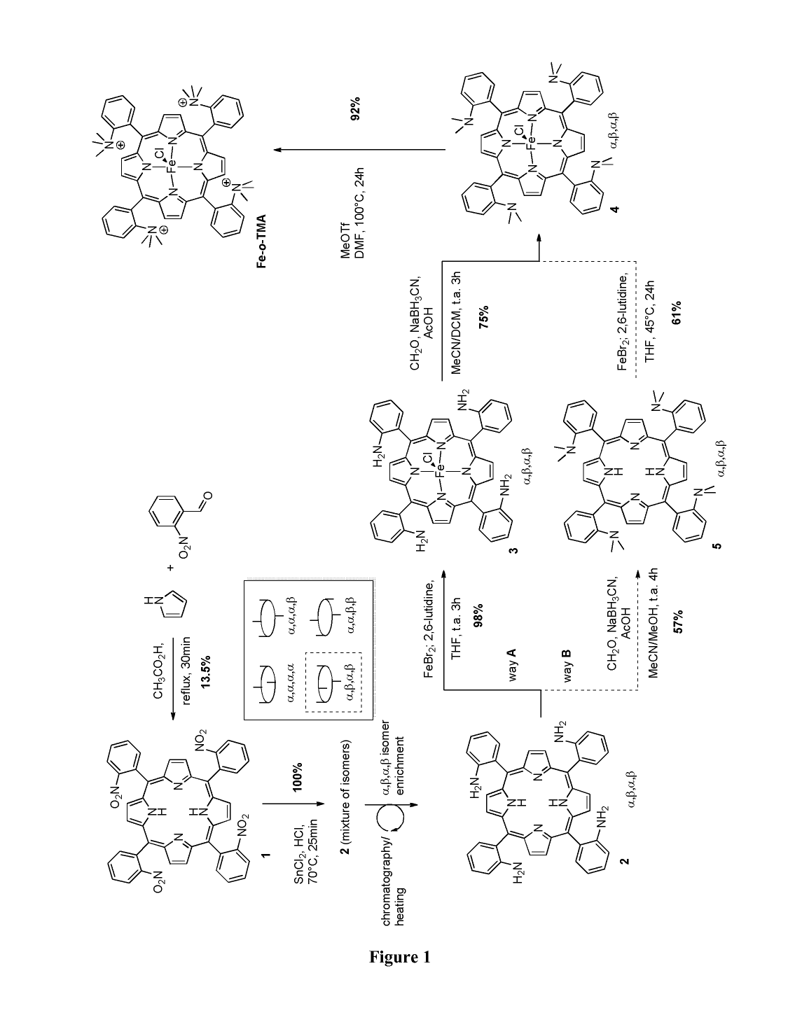

Path A (see FIG. 1). To a solution of porphyrin 3 (185 mg; 0.24 mmol; 1 eq.) in MeCN/CH₂Cl₂ (5/5 mL) is added formaldehyde (37% in H₂O; 721 μL; 9.69 mmol; 40 eq.) and sodium cyanoborohydride (76.1 mg; 1.21 mmol; 5 eq.). Glacial acetic acid (5 mL) is then poured dropwise and the reaction mixture is stirred for 4 hours at room temperature. The reaction mixture is evaporated, the residue is solubilized in CH₂Cl₂ (30 mL) and cautiously washed with saturated Na₂CO₃ solution (2×30 mL), saturated NaCl solution (2×15 mL) and water (1×20 mL). The organic phase is dried over MgSO₄, filtered, evaporated in vacuo and the residue is purified by column chromatography on silica gel (gradient elution from CH₂Cl₂/MeOH=100/0 to 95/5) affording the desired product as a purple powder (158 mg) in 75% yield.

Path B. A solution of 5 (30 mg; 0.038 mmol; 1 eq.) and 2,6-lutidine (89 μL; 0.76 mmol; 20 eq.) in freshly distilled THF (8 mL) is degassed with argon for 10 min. FeBr₂ (158 mg; 0.53 mmol; 14 eq.) is added and the reaction mixture is stirred for 20 hours at 40° C. Some remaining starting material could be observed by TLC, so more FeBr₂ (78 mg; 0.267 mmol; 7 eq.) are added and the reaction mixture is stirred for 5 h at 45° C. After evaporation in vacuo, the residue is solubilized in CH₂Cl₂ and washed with water (until aqueous phase gets colorless) and with saturated NaCl solution. The organic phase is then dried over MgSO₄, filtered, evaporated and purified by column chromatography on silica gel (CH₂Cl₂/Ethyl Acetate 90/10 followed by CH₂Cl₂/MeOH 9/1) affording the desired product as a purple powder in 61% yield.

HR-MALDI-TOF ([M−Cl]⁺) calculated for C₅₂H₄₈FeN₈: 840.3346 found: 840.2511.

UV-vis (DMF, λₘₐₓ/nm, log(s)/L·mol⁻¹·cm⁻¹): 426 (4.91), 583 (3.86), 631 (3.59), 703 (3.22)

IR (cm⁻¹): 2929w, 2843w, 2782w, 1591w, 1494m, 1429m, 1330m, 1201w, 1156w, 1107w, 1065w, 1053w, 997vs, 946m, 801m, 757m

### Chloro Iron(III) 5,10,15,20-tetra(o-N,N,N-Trimethylanilinium)porphyrin tetra(trifluoromethanesulfonate) (Fe-o-TMA

To a solution of porphyrin 4 (40 mg; 0.046 mmol; 1 eq.) in dry DMF (3 mL) under argon is added methyl trifluoromethanesulfonate (517 μL; 4.56 mmol; 100 eq.). The solution is stirred for 24 h at 100° C. under argon. Most of the DMF is evaporated under vacuum and the residual black waxy solid is solubilized in water (10 mL) and washed with CH₂Cl₂ (4×20 mL). The aqueous phase is evaporated and the brown solid is solubilized in water (5 mL) and purified by dialysis (membrane MWCO=1000 g/mol) against deionised water (5×90 min). After removal of water, the residue is dried in vacuo for 24 h affording a dark brown powder (65 mg) in 92% yield.

ESI-MS: [M+Cl⁻]⁴⁺ calculated for C₅₆H₆₀C₁FeN₈: 233.8489; found: 233.8489.

UV-vis (DMF, λₘₐₓ/nm, log(s)/L·mol⁻¹·cm⁻¹): 430 (4.90); 561 (3.81); 624 (3.43); 664 (3.28).

IR (cm⁻¹): 3176w, 2827vw, 1471m, 1260vs (TfO), 1225vs (TfO), 1158vs (TfO), 1028vs (TfO), 948w, 834w, 759w, 666w, 634vs (TfO).

### Example 2. Cyclic Voltammetry and Electrolysis

Methods and Instrumentation.

Cyclic Voltammetry.

The working electrode was a 3 mm-diameter glassy carbon (Tokai) disk carefully polished using decreasing size of diamond paste (from 15 to 1 μm), ultrasonically rinsed in absolute ethanol and dried before use or a mercury drop deposited on a 1 mm diameter gold disk. The counter-electrode was a platinum wire and the reference electrode was an aqueous SCE electrode. All experiments were carried out under argon or carbon dioxide atmosphere at 25° C., the double-wall jacketed cell being thermostated by circulation of water. Cyclic voltamograms were obtained by use of a Metrohm AUTOLAB instrument. Ohmic drop was compensated using the positive feedback compensation implemented in the instrument.

Preparative Scale Electrolysis. Electrolyzes were performed using a Princeton Applied Research (PARSTAT 2273) potentiostat. The experiments were carried out in a two-compartment cell with a glassy carbon crucible (the volume of the solution was 4 mL and active surface area was 12.7 cm²) or a mercury pool (active surface area was 5.1 cm²). The reference electrode was an aqueous SCE electrode and the counter electrode was a platinum wire in a bridge separated from the cathodic compartment by a glass frit, containing 0.2M NEt₄CH₃CO₂+0.1 M NBu₄PF₆ DMF solution. The electrolysis solution was purged with CO₂ during 20 min prior to electrolysis. Particular care was exerted to minimize the ohmic drop between working and reference electrodes. This was performed as follows: the reference electrode was directly immersed in the solution (without separated bridge) and put progressively closer to the working electrode until sustained oscillations appeared. It was then moved slightly away until the remaining oscillations were compatible with the catalytic current. The appearance of oscillations in this cell configuration does not require positive feedback compensation as it does with microelectrodes. The potentiostat+positive feedback compensation device system is equivalent to a self-inductance. Oscillations thus appear as soon as the resistance that is not compensated by the potentiostat comes close to zero as the reference electrode comes closer and closer to the working electrode surface.

Gas Detection. Gas chromatography analyses of gas evolved in the headspace during the electrolysis were performed with an Agilent Technologies 7820A GC system equipped with a thermal conductivity detector. CO and H₂ production was quantitatively detected using a CP-CarboPlot P7 capillary column (27.46 m in length and 25 μm internal diameter). Temperature was held at 150° C. for the detector and 34° C. for the oven. The carrier gas was argon flowing at 9.5 mL/min at constant pressure of 0.5 bars. Injection was performed via a 250-μL gas-tight (Hamilton) syringe previously degassed with CO₂. Conditions allowed detection of H₂, O₂, N₂, CO, and CO₂. Calibration curves for H₂ and CO were determined separately by injecting known quantities of pure gas.

Results.

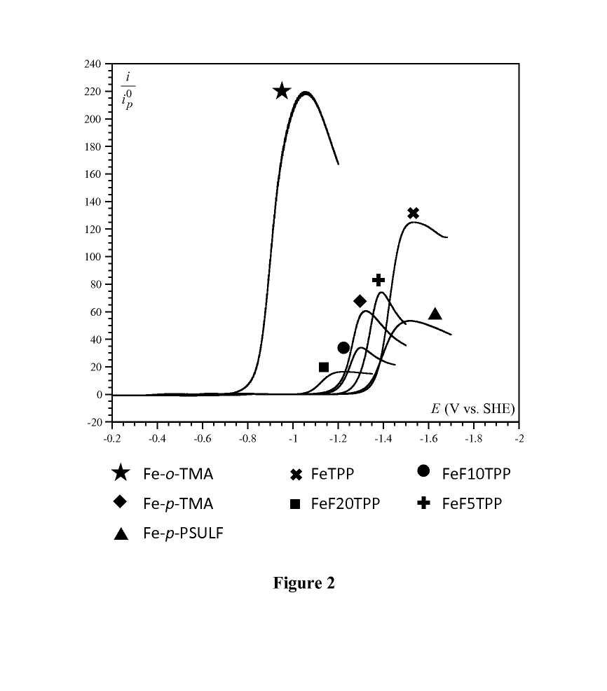

FIG. 2 shows the Fe^{I/0} cyclic voltammetric responses obtained under 1 atm CO₂ in the presence of 3 M phenol, with Fe-o-TMA, Fe-p-TMA, Fe-p-PSULF, FeTPP, FeF5TPP, FeF10TPP and FeF20TPP.

It immediately appears, before any treatment of the raw data, that the Fe-o-TMA is a far much better catalyst than any other molecules in the series both in terms of current and potential.

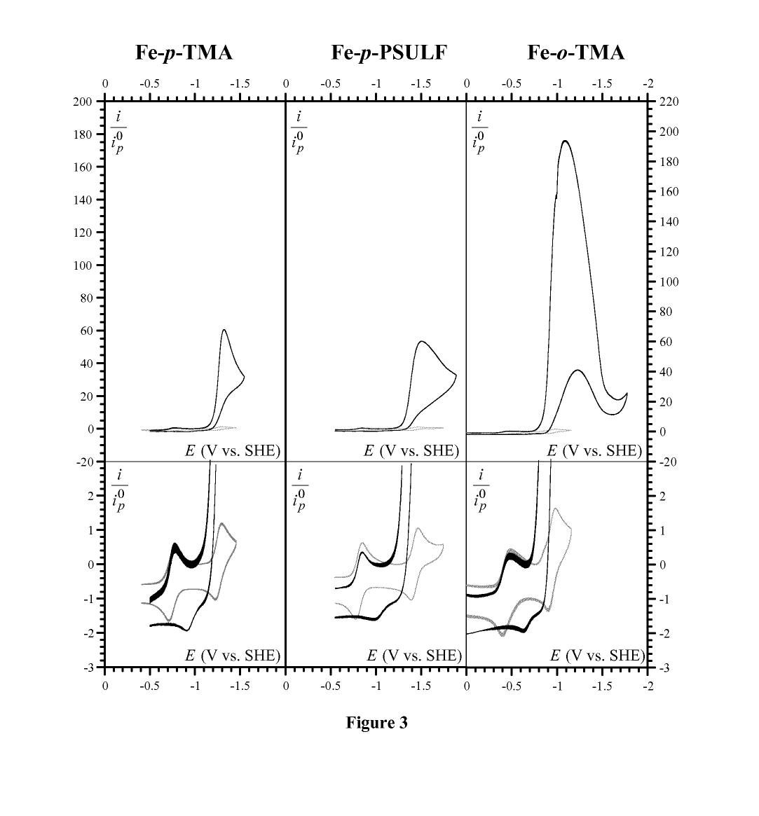

As seen in FIG. 3, the formation of CO is clearly attested by the observation of a cathodic shift of the Fe^{I}/Fe^{II} reoxidation wave on the reverse scan in the cyclic voltammetric catalytic responses of Fe-p-TMA, Fe-o-TMA and Fe-p-PSULF. It matches what can be observed in the cyclic voltammetry of the Fe^{II}/Fe^{I} couple in the presence of CO.

It is noticed (FIGS. 2 and 3) that the current-potential responses of Fe-p-TMA, Fe-o-TMA and Fe-p-PSULF show peaks instead of the plateaus expected for fast catalytic processes. It is assumed that this is due to the interference of secondary phenomena such as substrate or co-substrate consumption, inhibition by product and possibly other phenomena that all increase with the charge passed. One way of fighting the interference of such phenomena is to raise the scan rate, and thereby, decrease the charge passed, so as to get back to a S-shaped current potential responses and derive the rate constant from the ensuing plateau current.

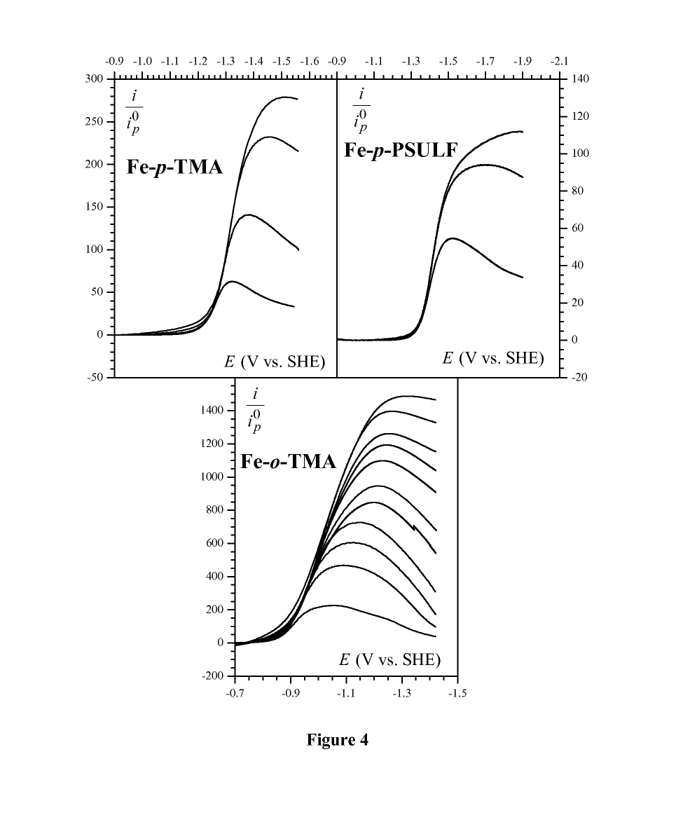

This is the treatment that has been applied to the raw cyclic voltammetric data as shown in FIG. 4. It is worth noting, en passant, that the scan rates required to reach an S-shaped CV responses are, as expected, the larger the stronger catalysis (in increasing order: Fe-p-PSULF, Fe-p-TMA, Fe-o-TMA).

FIG. 7 shows the faradaic yields and the CO/H₂ selectivity factor for Fe-o-TMA (at an overpotential of 220 mV) and Fe-p-TMA (at an overpotential of 450 mV) over 7 hours electrolysis time. In both cases the CO-vs.-H₂ selectivity is excellent, even slightly better in the first case than in the second. During this seven-hour experiments both catalysts appear stable. Fe-o-TMA appears stable even during much longer electrolysis times, up to at least 84 hours as reported in FIG. 8 at an overpotential of 220 mV at which the TOF is 10⁶ s⁻¹.

### Example 3: Benchmarking of Fe-o-TMA with Prior Art Complexes in Organic Medium

Benchmarking with other catalysts in terms of overpotential and turnover frequency in water does not seem possible at the moment.

A comparison with the characteristics of other catalysts obtained in an aprotic solvent such as DMF or acetonitrile was thus made.

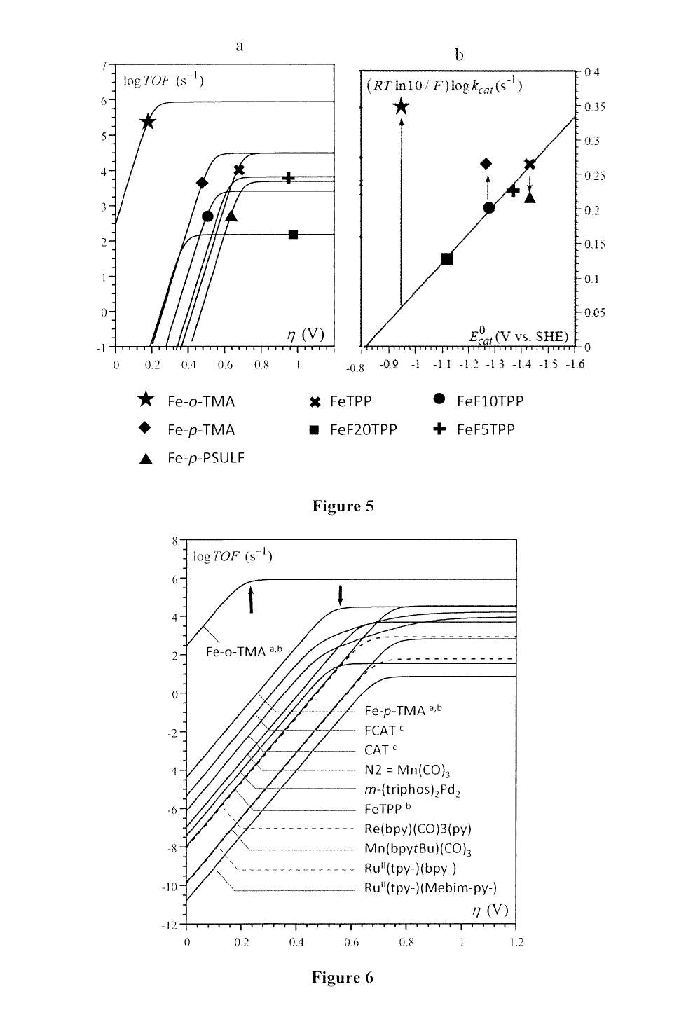

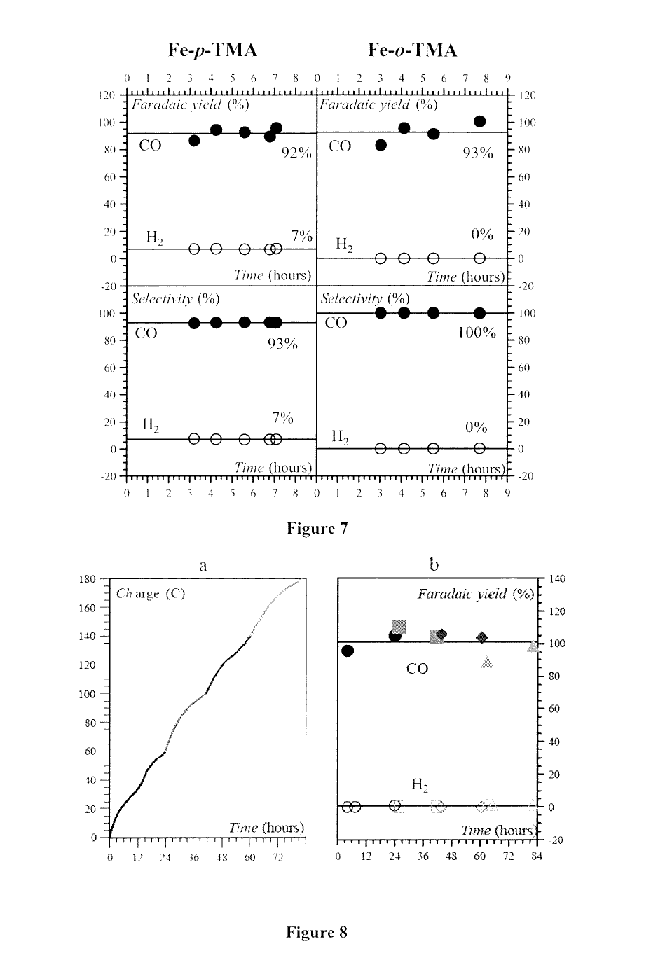

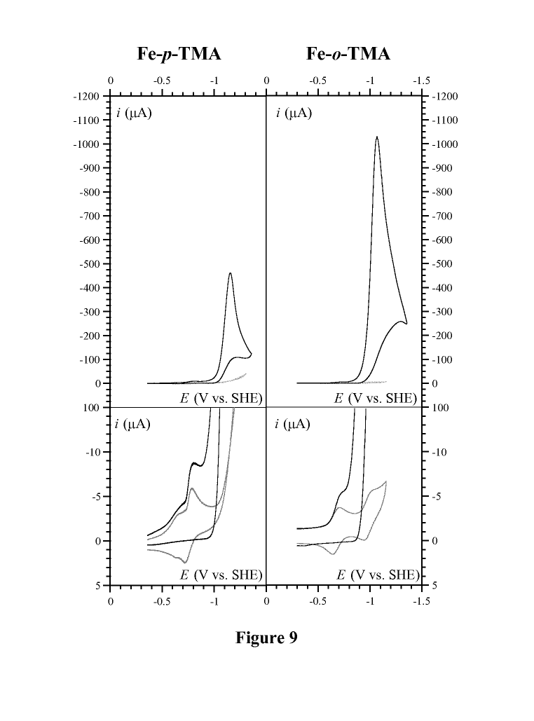

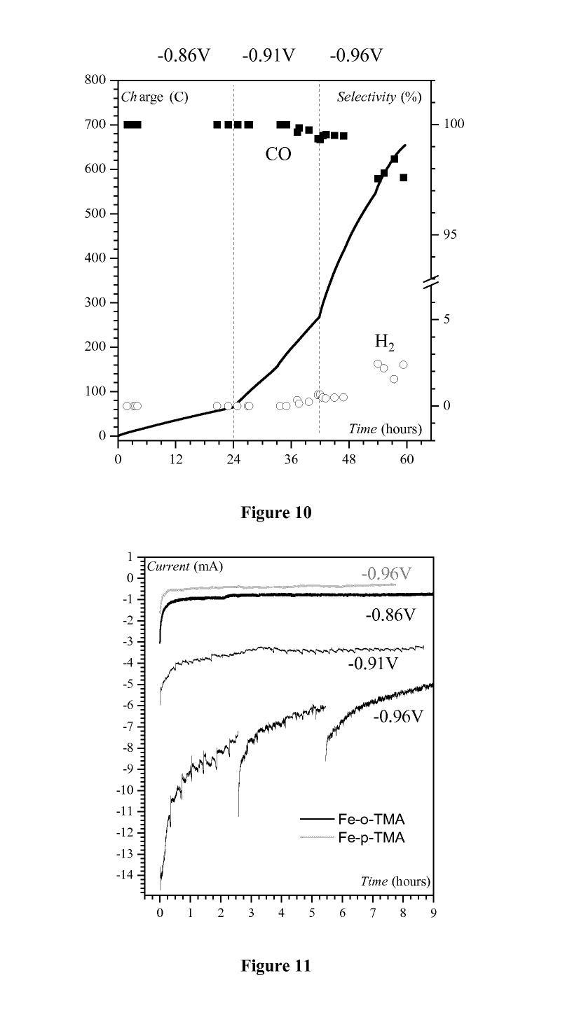

Combination of the foot-of-the wave analysis with increasing scan rates, which both minimize the effect of side-phenomena, allowed the determination of the turnover frequency as a function of the overpotential, leading to the “catalytic Tafel plot” for the Fe-o-TMA catalyst shown as the upper curve in FIG. 5. The turnover frequency (TOF), takes into account that the molecules that participate to catalysis are only those contained in the thin reaction-diffusion layer adjacent to the electrode surface in pure kinetic conditions. The overpotential, η, is the difference between the standard potential of the reaction to be catalyzed and the electrode potential. Correlations between TOF and η provide catalytic Tafel plots that are able to benchmark the intrinsic properties of the catalyst independently of parameters such as cell configuration and size. Good catalysts stand in the upper left corner and bad catalysts in right bottom corner. These plots allow one to trade between the rapidity of the catalytic reaction and the energy required to run it. The other Tafel plots shown in FIG. 6 are simply the repeat of what has been established in details in Costentin et al Proc. Natl. Acad. Sci. U.S.A. 2014, 111, 14990-14994.

The values of k_{cat} required to establish the catalytic Tafel plots and the k_{cat} vs. Eat for these three porphyrins may then be derived from the plateau current values, using the following equations. For the catalytic plateau current: iₚₗ=FSC_{cat}⁰\sqrt{D_{cat}}\sqrt{2k_{cat}}, and for the one-electron diffusion current at 0.1 V/s:

$${i}_{p}^{0} = FS \times 0.446 \times {C}_{cat}^{0} \sqrt{{D}_{cat}} \sqrt{\frac{Fv ( = 0.1 V \text{/} s )}{RT}} .$$

Using the ratio

$$\frac{{i}_{pl}}{{i}_{p}^{0}} = 2.24 \sqrt{\frac{2 {k}_{cat}}{0.1} \frac{RT}{F}}$$

avoids determining S (electrode surface area), C_{cat}⁰ and D_{cat} (concentration and diffusion coefficient of the catalyst, respectively). Thus:

$${k}_{cat} = {( \frac{{i}_{pl , v}}{{i}_{p , 0.1}^{0}} )}^{2} \frac{0.1}{{2.24}^{2}} \frac{F}{2 RT}$$

The values of k_{cat} thus obtained were then used to locate the catalytic Tafel plots of porphyrins (FIG. 5a) and to introduce the corresponding data points in the kcat vs. E_{cat}⁰ correlation diagram (FIG. 5b).

A through-space effect clearly appears for Fe-p-TMA in so far that its representative point stands above the through-structure correlation line. That this effect results from the positive charges borne by the substituents is confirmed by the observation that the introduction of negative charges in similar positions produces the reverse effect (FIG. 6b). Although clearly present, these effect are necessarily small since the charges are rather distant from the reacting center, viz., the initial adduct between CO₂ and the iron(0) complex.

These observations encouraged us to introduce positive charged substituents closer to the reacting center in spite of the expected synthetic difficulties related to steric congestion of this type of substituted iron-porphyrin (see the Experimental Section below). The result—Fe-o-TMA—proved to be the best catalyst of the whole iron porphyrin series with considerable gains in terms of overpotential and of turnover frequency as can be seen in FIGS. 5 and 6. The maximal turnover frequency is as high as 10⁶ s⁻¹ and the turnover frequency at zero overpotential larger than 300 s⁻¹.

The reason for this leap forward is most likely the stabilization of the initial iron(0) adduct by the interactions of the negative charge borne by the oxygens of CO₂ in this adduct with the nearby positive charges borne by the trimethylanilinium substituents on the porphyrin phenyls. The presence of phenol in large concentration then helps the proton-assisted reductive cleavage of one of the carbon-oxygen bond of CO₂. This is a particularly striking example of the power of close-distance through-space interactions in boosting of catalysis. Another type of close-distance through-space interactions as already been implemented to boost CO₂ reduction catalysis, albeit with a lesser efficiency, namely the introduction of ortho phenol groups in the porphyrin phenyls in which stabilization of the initial Fe⁰— CO₂ adduct is achieved by means of H-bonding. Comparison between the coulombic-interaction and H-bond-interaction series is shown in FIG. 6, as well as with the best examples that can be found in the literature. It again appears that Fe-o-TMA is the champion in all categories.

### Example 4: Catalysis in Water

Cyclic Voltammetry

The same experimental setup was used as in example 2.

The cyclic voltammetric response of Fe-p-TMA and Fe-o-TMA in water is reported on FIG. 9. Under Argon, Fe-o-TMA features two reversible waves attributed to the Fe^{II}/Fe^{I} and Fe^{I}/Fe⁰ couples while for Fe-p-TMA, only the Fe^{II}/Fe^{I} couples appears as a reversible wave. This already indicates a poor reactivity of the Fe⁰ state of Fe-o-TMA toward the proton reduction reaction.

Under CO₂, the two catalysts present a strong catalytic wave. The highest being the one of Fe-o-TMA. Furthermore, the onset of the catalytic wave of Fe-o-TMA is approximately 125 mV more positive than the one of Fe-p-TMA.

For very efficient catalysts, the substrate diffusion can become the limiting factor of the catalysis. In this specific case of total catalysis, the peak current of the catalytic wave is independent of the kinetic constant and the catalyst concentration and can be calculated with the following equation:

$${i}_{p} = 0.5 \times 2 \times {FSC}_{CO 2}^{0} \sqrt{\frac{{D}_{CO 2} Fv}{RT}}$$

$${i}_{p} = 1.27 mA$$

$$S = 0.07 {cm}^{2} ( d = 3 mm )$$

$${C}_{CO 2}^{0} = {30.10}^{- 6} mol \cdot {cm}^{- 3}$$

$${D}_{CO 2} = {1.10}^{- 5} {cm}^{2} \cdot {s}^{- 1}$$

$$F = 96500 C \cdot {mol}^{- 1}$$

$$V = 0.1 V \text{/} s \\ R = 8.314 J \cdot {mol}^{- 1} \cdot {K}^{- 1}$$

$$T = 293 K$$

The experimental peak current for Fe-o-TMA is measured at 1.03 mA, which indicates that a total catalysis regime is almost reached.

Theses cyclic voltammetric experiments clearly indicate that Fe-o-TMA is a better catalyst than Fe-p-TMA both in term of kinetic rate and overpotential.

Preparative-Scale Electrolysis in Water.

Electrolyses were performed using a Princeton Applied Research PARSTAT 4000 potentiostat interfaced with VersaStudio software. The experiment was carried out in a two-compartment cell. The working electrode was a glassy carbon crucible (active surface area was 15 cm²). The reference electrode was an aqueous SCE electrode and the counter electrode a platinum grid in a bridge separated from the cathodic compartment by a glass frit. Ohmic drop was minimized by immersing directly the reference electrode into the solution as close as possible to the working electrode. The electrolysis cell was purged with CO₂ for 15 min before electrolysis then sealed for quantitative experiments or under a continuous flux for the long-time-scale electrolysis to avoid the CO₂ consumption.

The cathodic electrolyte solution consisted in aqueous 0.5 mM Fe-o-TMA in 0.1M KCl and 0.5M KHCO₃ (pH 7.2) saturated with CO₂, while the anodic electrolyte solution consisted in an aqueous solution of phosphate buffer (0.2M) at pH 7.1.

Gas Detection.

Gas chromatography analyses of gas evolved in the headspace during the electrolysis were performed with the same techniques than detailed in Example 3.

Results

| | Potential | | | | | | |
|---|---|---|---|---|---|---|---|
| | (V | | | | | | Selectivity |
| Catalyst | vs.NHE) | Time | Current | | Charge © | TON (CO/H₂) | (CO/H₂) |
| Fe-p-TMA | −0.96 V | 7 h 45 | ~360 | μA | 11.7 | 37.8/1.6 | 96/4 |
| Fe-o-TMA | −1.86 V | 24 h | ~800 | μA | 64.8 | 111/0 | 100/0 |
| Fe-o-TMA | −0.91 V | 9 h 10 | 3 -> 2.6 | mA | 92.8 | 159/0 | 100/0 |
| Fe-o-TMA | −0.91 V | 8 h 40 | 3.4 | mA | 110 | 190/1 | 99.5/0.5 |
| Fe-o-TMA | −0.96 V | 2 h 35 + | 14 -> 2.7 | mA | 86.3 + | 660/6.25 | 99/1 |
| | | 2 h 55 + | | | 71.6 + | | |
| | | 6 h 13 + | | | 121.1 + | | |
| | | 2 h 50 + | | | 62.4 + | | |
| | | 3 h 15 | | | 44.29 | | |

A series of preparative scale electrolyses were performed at three different applied potentials (−0.86V, −0.91V and −0.96V vs. NHE) over a total of 60 h (FIG. 10). During the whole experiment, the system remained very selective towards CO₂ reduction with a faradaic efficiency above 99% for CO. The almost linear evolution of the charge with time indicates a quite good stability of the catalyst.

Comparison with Fe-p-TMA

A control electrolysis of 7 h 45 at −0.96V vs. NHE has been performed with Fe-p-TMA, with the same setup used for Fe-o-TMA, The measured current density was more than an order of magnitude lower for Fe-p-TMA compared to Fe-o-TMA (FIG. 11). Moreover, the selectivity was slightly lower for Fe-p-TMA (96% selectivity for CO, versus >99% for Fe-o-TMA).

### SUMMARY

Without wishing to be bound by theory, it may be concluded that through-space substituent effects on the catalysis of the electrochemical CO₂-to-CO conversion by iron(0)-tetraphenyl porphyrins has been first investigated and evidenced by the introduction of four positively charged trimethylanilinium groups in para-position of the TPP phenyls (Fe-p-TMA). The assignment of this catalysis boosting effect to the coulombic interaction of these positive charges with the negative charges borne by the initial Fe⁰—CO₂ adduct has been further confirmed by the negative catalytic effect observed when the four positive charges in Fe-p-TMA are replaced by four negative charges borne by sulfonate groups installed in the para-position of the TPP phenyls (Fe-p-PSULF). Optimization of the catalysis by means of coulombic stabilization of the initial Fe⁰— CO₂ adduct was reached when four positively charged trimethylanilinium groups are introduced in the ortho position of the TPP phenyls (Fe-o-TMA). The exceptional efficiency of the resulting catalyst is unprecedented with maximal turnover frequency as high as 106 s⁻¹ and is reached at a low overpotential of 220 mV. The selectivity for CO production is close to 100% while the catalyst appears extremely stable upon long term electrolysis, with no significant alteration for more than three and a half days.

1.-15. (canceled)

16. An iron complex of a porphyrin of formula (I): 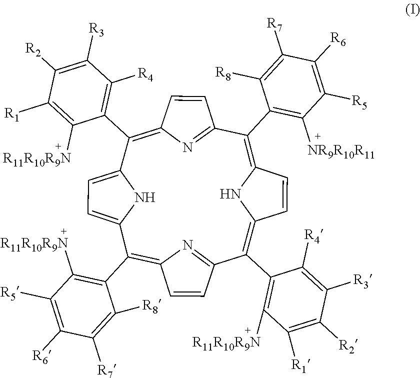
wherein R₁ to R₈ and R₁′ to R₈′ are independently selected from the group consisting of H, OH, F, and C₁-C₆-alkyl,
provided that at least 2 of R₁-R₄ are H, at least 2 of R_{1′}-R_{4′} are H, at least 2 of R₅-R₈ are H, and at least 2 of R_{5′}-R_{8′} are H, and
R₉, R₁₀ and R₁₁ are independently selected from a C₁-C₄-alkyl group,
or atropisomers thereof,
and salts thereof.

17. The iron complex of claim 16, wherein R₉, R₁₀, and R₁₁ are a methyl group.

18. The iron complex of claim 16, wherein R₁ to R₈ and R₁′ to R₈′ are selected from the group consisting of H and C₁-C₆-alkyl.

19. The iron complex of claim 16, wherein the porphyrin of the invention is of formula (Ia): 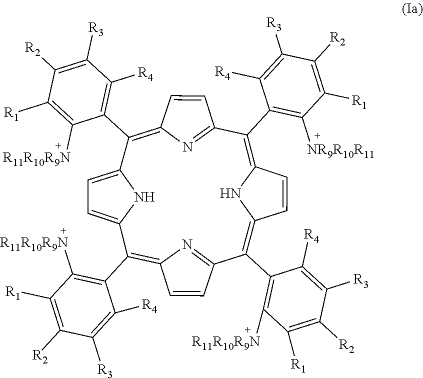
with R₁ to R₄ and R₉, R₁₀, and R₁₁ as defined in claim 16,
or atropisomers thereof, and salts thereof.

20. The iron complex of claim 16, wherein the porphyrin of the invention is of formula (Ib): 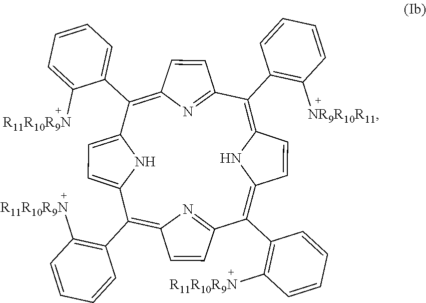
with R₉, R₁₀, and R₁₁ as defined in claim 16, or atropisomers thereof, and salts thereof.

21. The iron complex of claim 20, wherein the porphyrin of the invention is: 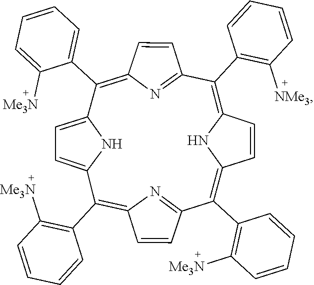
or atropisomers thereof, and salts thereof.

22. A two-compartment electrochemical cell comprising at least:
a cathodic compartment with a cathode and a cathodic electrolyte solution comprising a cathodic solvent and a cathodic supporting electrolyte, and the substrate CO₂,
an anodic compartment with an anode and an anodic electrolyte solution comprising a solvent and an anodic supporting electrolyte,
a power supply providing the energy necessary to trigger the electrochemical reactions involving the substrate,
and further comprising the iron complex of claim 16.

23. The electrochemical cell of claim 22, wherein CO₂ gas is present only in the cathodic compartment and the CO₂ pressure in the cathodic compartment of the electrochemical cell is of between 1 bar and 30 bars.

24. The electrochemical cell of claim 22, wherein the solvent of the electrolyte solutions is selected from dimethylformamide, acetonitrile, water, or mixtures thereof.

25. The electrochemical cell of claim 24, wherein, when the solvent is water, the cathodic supporting electrolyte is devoid of buffer, and the anodic supporting electrolyte comprises a phosphate buffer.

26. The electrochemical cell of claim 24, wherein, when the solvent comprises dimethylformamide and/or acetonitrile, said solvent further comprises a proton donor with a pKa value in DMF of between 18 and 31.

27. A method of reducing electrochemically CO₂ into CO using an iron complex of a porphyrin of formula (I): 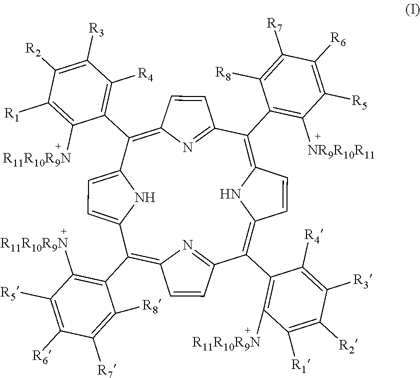
wherein R₁ to R₈ and R₁′ to R₈′ are independently selected from the group consisting of H, OH, F, and C₁-C₆-alkyl,
provided that at least 2 of R₁-R₄ are H, at least 2 of R_{1′}-R_{4′} are H, at least 2 of R₅-R₈ are H, and at least 2 of R_{5′}-R_{8′} are H, and
R₉, R₁₀ and R₁₁ are independently selected from a C₁-C₄-alkyl group,
or atropisomers thereof,
and salts thereof
with iron at the oxidation state of Fe(0), as catalyst or the electrochemical cell of claim 24.

28. The method of claim 27, wherein, in the electrochemical cell, when a mixture of CO and H₂ (syngas) is produced, the pH of the aqueous solution and the potential applied to the cathode are adjusted so as to tune the CO/H₂ molar ratio of the produced gas.

29. The method of claim 27, wherein the iron complex of claim 1 is used as homogenous catalyst or is immobilized on at least one electrode using a binder, optionally containing conductive materials as additives.

30. The electrochemical cell of claim 26, wherein the proton donor is selected from the group consisting of water, trifluoroethanol, phenol, and acetic acid.
